(19) United States
(12) Patent Application Publication
(10) Pub. No.: US 2021/0184538 A1
(43) Pub. Date: Jun. 17, 2021

(54) FLINGER WITH NOISE REDUCTION STRUCTURE AND ELECTRIC MOTOR WITH THE FLINGER

(71) Applicant: FANUC CORPORATION, Yamanashi (JP)

(72) Inventor: Yasuhito Mukai, Yamanashi (JP)

(73) Assignee: FANUC CORPORATION, Yamanashi (JP)

(21) Appl. No.: 17/185,185

(22) Filed: Feb. 25, 2021

Related U.S. Application Data
(62) Division of application No. 16/407,528, filed on May 9, 2019.

(30) Foreign Application Priority Data
Jun. 13, 2018 (JP) 2018-112633

(51) Int. Cl. H02K 5/24; H02K 5/15; B23Q 11/08; B23Q 11/00

(52) U.S. Cl. CPC H02K 5/24; B23Q 11/0032; B23Q 11/0883; H02K 5/15

(57) ABSTRACT

A flinger reducing a noise associated with rotation of an electric motor, and an electric motor with the flinger. The flinger fixed to a rotating shaft of the electric motor includes a plurality of tapped holes provided in an end face on an electric motor, and a cut-out cutting out a part of each of the tapped holes. The tapped hole of the flinger has a depth less than a depth of a tapped hole of a flinger in the related art by a distance equivalent to a depth of the cut-out, so that a natural frequency of an air column formed in the tapped hole increases. Thus, when the flinger is used, rotation speed causing increase in noise during rotation can be shifted to higher rotation speed.

### RELATED APPLICATIONS

This is a division of U.S. application Ser. No. 16/407,528, filed May 9, 2019, which claims priority to Japanese Application No. 2018-112633, filed Jun. 13, 2018, the contents of which are herein incorporated by reference.

### BACKGROUND OF THE INVENTION

### 1. Field of the Invention

The present invention relates to a flinger with a structure for reducing a noise caused during rotation and an electric motor with the flinger.

### 2. Description of the Related Art

In many cases, an electric motor (rotary electric machine) for rotating a spindle, etc., of a machine tool includes a component called a flinger including a plurality of tapped holes so that a weight such as a set screw is screwed into some of the tapped holes to enable balance adjustment during rotation. Thus, existence of the tapped hole without the weight screwed causes a noise when the electric motor (flinger) operates at a high-speed rotation.

It is known in the related arts to reduce this kind of noise as follows: a cover for covering an end face of a spindle (e.g., refer to JP 2000-218465 A) is provided; and a countersunk head screw is screwed into a tapped hole as a weight, and a face provided with the tapped hole is made substantially flat (e.g., refer to JP 2008-132579 A).

### SUMMARY OF THE INVENTION

It is desirable a structure capable of effectively reducing a noise associated with rotation of an electric motor without requiring operation of mounting a cover, screwing a countersunk head screw, etc.

An aspect of the present disclosure is a flinger mounted in an electric motor including a stator, a rotor with a rotating shaft rotatable about an axis of the stator, and a front bearing and a rear bearing configured to rotatably support the rotating shaft, the flinger being mounted to one or both of a portion of the rotating shaft forward of the front bearing along the axis and a portion of the rotating shaft rearward of the rear bearing along the axis, the flinger having a plurality of tapped holes, and a cut-out cutting out a part of the respective tapped holes.

Another aspect of the present disclosure is a flinger mounted in an electric motor including a stator, a rotor with a rotating shaft rotatable about an axis of the stator, and a front bearing and a rear bearing configured to rotatably support the rotating shaft, the flinger being mounted to one or both of a portion of the rotating shaft forward of the front bearing along the axis and a portion of the rotating shaft rearward of the rear bearing along the axis, the flinger having a plurality of tapped holes, and partitions formed downstream of the respective tapped holes in a rotation direction of the rotating shaft.

Yet another aspect of the present disclosure is an electric motor including the flinger according to any one of the aspects described above of the present disclosure.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 illustrates a schematic structure of an electric motor according to a preferred embodiment of the present disclosure;

FIG. 2 illustrates a first example of a flinger provided in the electric motor of FIG. 1;

FIG. 3 illustrates a structural example of a flinger in the related art;

FIG. 4 illustrates noise reduction action of the flinger of FIG. 2;

FIG. 5 is a graph for illustrating noise reduction effect of the flinger of FIG. 2;

FIG. 6 illustrates another structural example of the flinger according to the first example;

FIG. 7 illustrates yet another structural example of the flinger according to the first example;

FIG. 8 illustrates a second example of the flinger provided in the electric motor of FIG. 1;

FIG. 9 is a partially enlarged view of a flinger in the related art;

FIG. 10 is a partially enlarged view of the flinger of FIG. 8;

FIG. 11 illustrates an example of reducing an inflow of air into a tapped hole with a partition;

FIG. 12 is a graph for illustrating noise reduction action of the flinger of FIG. 8; and

FIG. 13 illustrates another structural example of the flinger according to the second example.

### DETAILED DESCRIPTION

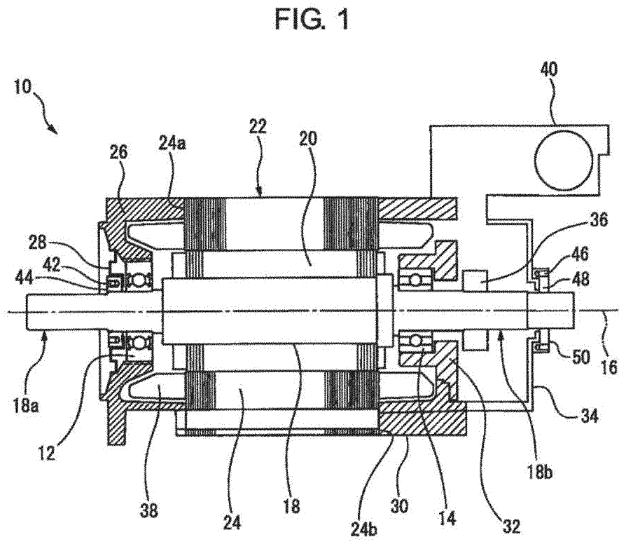

FIG. 1 is a cross-sectional view in an axial direction illustrating a schematic structure of an electric motor (rotary electric machine) 10 according to a preferred embodiment of the present disclosure. The electric motor 10 includes a rotating shaft 18 rotatably supported about an axis 16 by a first bearing (front bearing) 12 and a second bearing (rear bearing) 14, a rotor 20 rotating integrally with the rotating shaft 18 while fit to an outer circumferential surface of the rotating shaft 18, and a stator 22 having a substantially cylindrical shape extending along the axis 16 to surround the rotor 20.

The front bearing 12 is provided near a front end 18a of the rotating shaft 18 and supported by a front housing 26 fixed by screwing, etc., to a front end face 24a of a stator core 24. The front housing 26 extends from the front end face 24a of the stator core 24 toward the front end 18a of the rotating shaft 18 and supports a part of the rotating shaft 18 and the front bearing 12 (an outer race thereof). The front housing 26 is also mounted with a front cover 28 having a substantially annular shape. The front end 18a of the rotating shaft 18 protrudes from the front housing 26 and the front cover 28, and the rotating shaft 18 functions as an output shaft directly or indirectly connected to a spindle of a machine tool such as a lathe or a machining center, for example. Note that in the present specification, the output shaft side (left side in FIG. 1) and the opposite side thereof (right side in FIG. 1) are respectively referred to as “front” and “rear”, for convenience.

The rear bearing 14 is provided near a rear end 18b of the rotating shaft 18 opposing the front end 18a of the rotating shaft 18. The stator core 24 is fixed at its rear end face 24b with a rear housing 30 by screwing etc., and the rear housing 30 is fixed with a support ring 32 by screwing etc., the support ring 32 supporting the rear bearing 14 (an outer race thereof). The rear end 18b of the rotating shaft 18 protruding from the rear housing 30 protrudes from a rear cover 34 mounted to the rear housing 30. The rotating shaft 18 is also mounted at the rear end 18b with an encoder 36 configured to detect rotational position, rotation speed, etc., of the rotating shaft 18.

The stator 22 includes the stator core 24 including a plurality of electromagnetic steel sheets that are laminated and a coil 38 wound around a protrusion (not illustrated) on an inner circumferential surface of the stator core 24. The coil 38 is fixed to the stator core 24 by a resin, etc. The coil 38 extends along the rotational axis 16 so as to protrude from both ends of the stator core 24, and is connected to a lead wire (not illustrated) led out of a terminal box 40. The coil 38 generates a rotating magnetic field by using a current supplied through the lead wire, and the rotor 20 is rotated integrally with the rotating shaft 18 by the generated rotating magnetic field.

In the specification of the present application, the term, “radially outward” represents a direction away from the rotational axis 16 in a cross section, and the term, “radially inward” represents a direction approaching the rotational axis 16 in the cross section. In addition, the term, “axis direction”, or the term, “axial direction” represents a direction parallel to the rotational axis 16.

The electric motor 10 includes at least one flinger (two in the example illustrated) that rotates integrally with the rotating shaft 18 to enable balance adjustment during rotation. More specifically, a flinger (labyrinth) 44 formed with a plurality of tapped holes 42 extending axially is fixed, by interference fit, etc., to a portion of rotating shaft 18 forward of the front bearing 12 along the axis 16 (the vicinity of the front cover 28 in the example illustrated) so that contamination of foreign materials into the electric motor can be prevented and balance adjustment during rotation can be performed by screwing a weight (not illustrated) such as a set screw into at least one of the tapped holes 42. Likewise, a flinger 48 formed with a plurality of tapped holes 46 extending axially is fixed, by interference fit, etc., to a portion of rotating shaft 18 rearward of the rear bearing 14 along the axis 16 (the vicinity of the rear cover 34 in the example illustrated) so that contamination of foreign materials into the rear cover 34 can be prevented and balance adjustment during rotation can be performed by screwing a weight (not illustrated) such as a set screw into some of the tapped holes 46.

While the flinger is provided on each of the front and rear sides the rotating shaft 18 in the example illustrated, the flinger may be provided only on any one of the sides. The flinger 44 and the flinger 48 each may have the same basic structure and function, so that only the flinger 48 on the rear side will be described below.

### First Example

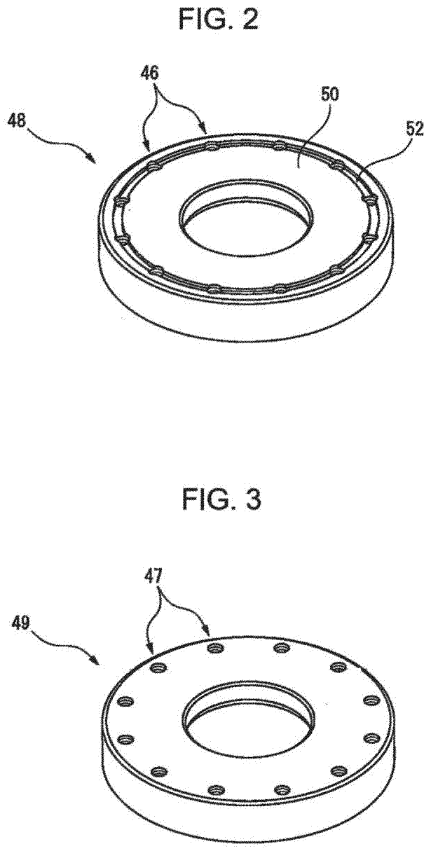

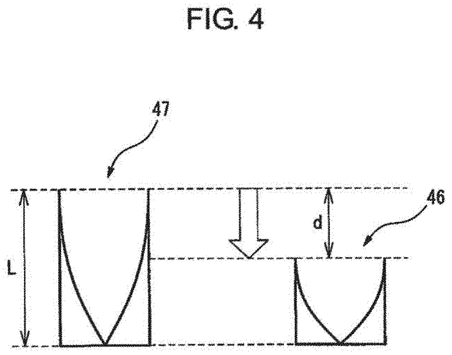

FIG. 2 is a perspective view illustrating a structural example of the flinger 48 according to a first example. FIG. 3 is a perspective view illustrating a structural example of a flinger 49 in the related art as a comparative example. The flinger 48 includes the plurality of tapped holes 46 into which a weight for balance adjustment is detachable, and a cut-out 52 cutting out a part of each of the tapped holes 46 (female screw). The tapped holes 46 and the cut-out 52 are here formed in an end face 50 of the flinger 48 on an opposite side in an axial direction of the electric motor 10 to a side facing the inside of the electric motor 10. More specifically, the cut-out 52 is formed as a recess cutting out each of the tapped holes from an open-end (here the end face 50) of each of the tapped holes 46 by a predetermined distance (less than a depth of each tapped hole), and is an annular groove in the example illustrated. However, the recess is not limited to this, and a recess such as a counterbored hole with a diameter more than that of each of the tapped holes 46 and an axial length less than that thereof may be formed concentrically with the corresponding one of the tapped holes 46, for example. This kind of cut-out causes an air column formed in each of the tapped holes 46 to substantially have a length less than an air column formed in each of the tapped holes 47 of FIG. 3, as described above.

FIG. 4 illustrates noise reduction action of the flinger 48 illustrated in FIG. 2. Here, the tapped hole 47 (refer to FIG. 3) provided in the flinger 49 in the related art illustrated in FIG. 3 will be compared with the tapped hole 46 of the flinger 48.

In each tapped hole formed in the flinger, rotation of the electric motor causes in- and outflow of air, so that each tapped hole serves as a kind of closed pipe during rotation. At this time, a natural frequency “f” of the closed pipe (air column) is expressed by Expression (1) below, where “V” is sonic velocity, and “L” is a length of the air column (n=1, 2, 3, . . . ). From Expression (1), it is found that as the length L of the air column decreases, the natural frequency f increases.

f₂ₙ₋₁=(2n−1)/4L·V (1)

Here, the tapped hole 46 of the flinger 48 according to the first example has a depth (a length of an air column) less than a depth (a length of an air column) of the tapped hole 47 of the flinger 49 in the related art by a distance equivalent to a depth “d” of the groove 52, so that the natural frequency increases. Thus, when the flinger 48 is used, rotation speed causing increase (maximization) in noise during rotation can be shifted to higher rotation speed than when the flinger 49 is used.

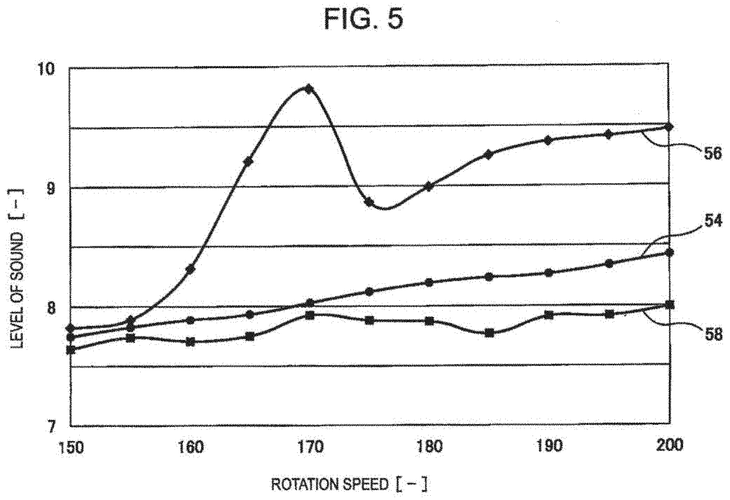

FIG. 5 is a graph for illustrating noise reduction effect when the flinger 48 illustrated in FIG. 2 is mounted to the electric motor 10. In FIG. 5, the horizontal axis represents a dimensionless number in proportion to rotation speed of the electric motor, and the vertical axis represents a dimensionless number in proportion to a level of sound caused by rotation of the electric motor. The level of sound was measured at a fixed position away from the flinger by a predetermined distance. Measurement results using the flinger 48 of FIG. 2 are shown as a graph 54, measurement results using the flinger 49 of FIG. 3 are shown as a graph 56, and measurement results using the flinger 49 of FIG. 3 with the tapped holes 47 all of which were filled with respective set screws, etc., (almost equivalent to that without the tapped hole 47) are shown as a graph 58 as another (ideal) comparative example.

As can be seen from FIG. 5, when the flinger 49 was used, a level of sound at a rotation speed of about 170 became maximum (the graph 56). When the flinger 48 is used, the natural frequency increases more than the natural frequency of the flinger 49 as described above, and thus, it is conceivable that a level of sound becomes maximum in a range of a rotation speed more than 200. Thus, when the rotation speed of the electric motor is within a practical range (200 or less), using the flinger 48 enables a noise level to be greatly reduced from that of the flinger in the related art and to be nearly close to that of an ideal product (graph 58).

For FIG. 4, it is conceivable that a tapped hole may be simply reduced in length based on an idea that a shorter air column can reduce a noise more. However, in that case, a set screw, etc., needs to be reduced in length so as not to greatly protrude from an end face of a flinger (i.e., the set screw is reduced in weight). This is unfavorable because it is difficult to achieve an original function of balance adjustment. Then, in the first example, the cut-out is provided in the end face to reduce a depth affecting a noise level (a length of an air column) without changing a depth of the tapped hole from the end face, so that a set screw with the same length as that in the related art can be used and a noise can be prevented.

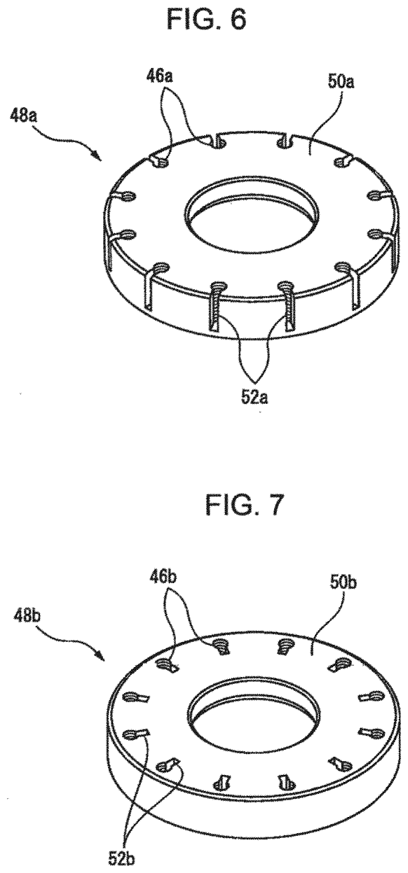

FIG. 6 illustrates a structural example of a flinger 48a as a modification of the first example. The flinger 48a includes the plurality of tapped holes 46a into which a weight for balance adjustment is detachable, and cut-outs 52a cutting out a part of the corresponding tapped holes 46a (female screw). The tapped holes 46a and the cut-outs 52a are here formed in an end face 50a of the flinger 48a on an opposite side in an axial direction of electric motor 10 to a side facing the inside of the electric motor 10. The cut-outs 52a are each formed as a slit cutting out a part of a lateral portion of the corresponding one of the tapped holes 46a in a longitudinal direction of the tapped hole 46a. In this case, each of the tapped holes 46a does not have a cylindrical column shape, so that the air column itself as illustrated in FIG. 4 is not formed even by rotation of the electric motor. This enables a noise during rotation to be greatly reduced even when the flinger 48a is used as compared with that in the related art.

FIG. 7 illustrates a structural example of a flinger 48b as another modification of the first example. The flinger 48b includes the plurality of tapped holes 46b into which a weight for balance adjustment is detachable, and cut-outs 52b cutting out a part of the corresponding tapped holes 46b (female screw). The tapped holes 46b and the cut-outs 52b are here formed in an end face 50b of the flinger 48b on an opposite side in an axial direction of the electric motor 10 to a side facing the inside of the electric motor 10. The cut-outs 52b are each formed as a slit cutting out a part of a lateral portion of the corresponding one of the tapped holes 46b in a longitudinal direction of the tapped hole 46b as with the cut-outs 52a. However, while the cut-outs 52a are each opened in an outer lateral face of the flinger 48a, the cut-outs 52b is formed so as not to be opened in an outer lateral face of the flinger 48b. Thus, when the flinger 48b is used, it is expected not only noise reduction effect due to no formation of an air column as in the flinger 48a, but also higher noise reduction effect due to a less turbulent flow of air in the periphery of the outer lateral face of the flinger 48b during rotation than that when the flinger 48a is used.

While the cut-out (slit) is formed through overall length of each tapped hole in each of FIGS. 6 and 7, even the cut-out formed in a part of each tapped hole in its longitudinal direction enables an air column to be substantially reduced more in length than that in the related art, thereby enabling a certain noise reduction effect to be acquired. In addition, the “longitudinal direction” (of a tapped hole) of the present disclosure is not limited to a direction strictly parallel to the axial direction of the tapped hole, and includes a direction with an angle 10° or less, 20° or less, or 30° or less, with respect to the axial direction, for example. The slit is also not limited to a linear shape, and may be a curved shape or a spiral shape, for example.

### Second Example

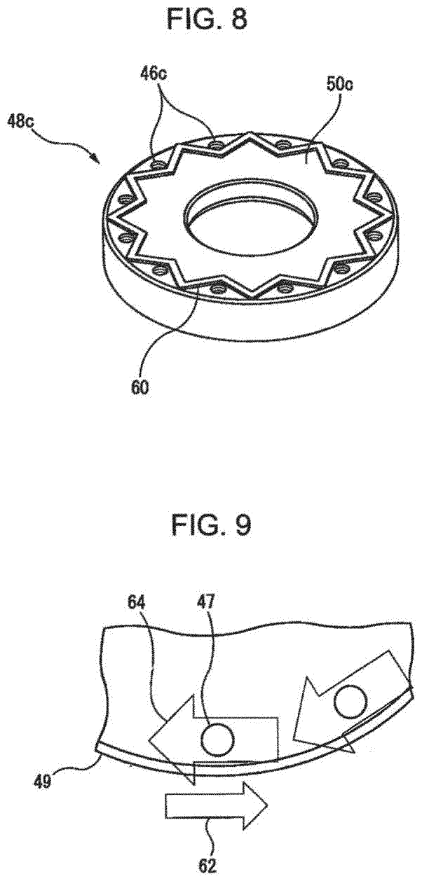

FIG. 8 is a perspective view illustrating a structural example of a flinger 48c according to a second example. The flinger 48c includes a plurality of tapped holes 46c into which a weight for balance adjustment is detachable, and a partition 60 formed downward of each of the tapped holes 46c in a rotation direction of the rotating shaft 18. The tapped holes 46c and the partition 60 are here formed in an end face 50c of the flinger 48c on an opposite side in an axial direction of the electric motor 10 to a side facing the inside of the electric motor 10. The partition 60 is formed in a portion downstream of each of the tapped holes 46c on the end face 50c. While the partition 60 is formed as a protrusion in a star shape formed both sides of each of the tapped holes 46c in the rotation direction in the example illustrated, the partition 60 is not limited to this.

FIGS. 9 to 11 each illustrate operation effect of the partition 60. In the flinger 49 in the related art (refer to FIG. 3), a flow of air in a substantially opposite direction to a rotation direction 62 (illustrated by an arrow 64) occurs in the vicinity of each of the tapped holes 47 when an electric motor is operated, as in FIG. 9 illustrated as a comparative example. Then, a predetermined amount of air flows into and out from each of the tapped holes 47 to cause a noise.

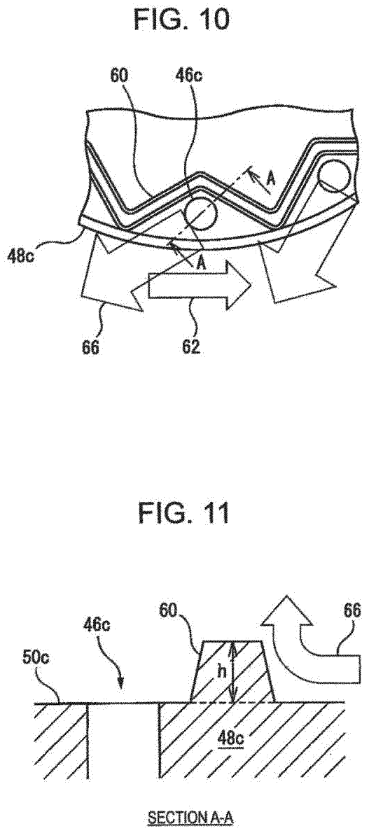

In contrast, in the flinger 48c according to the second example, the partition 60 provided in the portion downstream of each of the tapped holes 46c in the rotation direction 62 on the end face 50c deflects a flow of air in a substantially opposite direction to the rotation direction 62 (illustrated by an arrow 66) as illustrated in FIG. 10 (more specifically, the air is released in a direction away from the end face 50c as illustrated in FIG. 11), so that an in- and outflow rate of air into and from each of the tapped holes 46 can be reduced more as compared with the flinger in the related art illustrated in FIG. 9. As a result, a noise during rotation can be reduced.

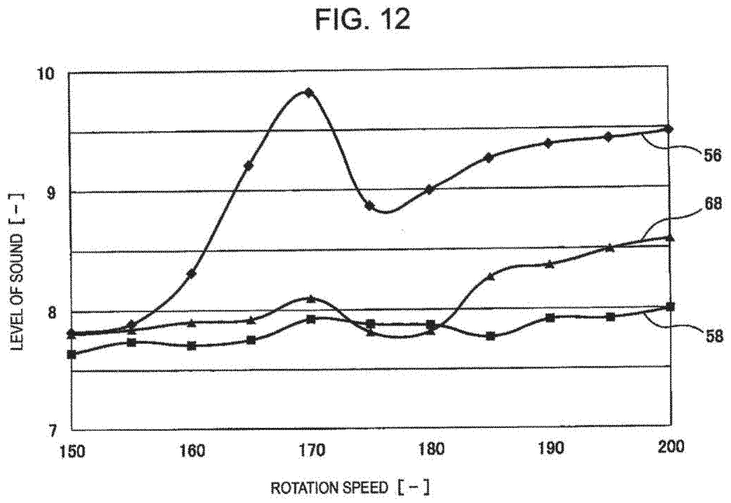

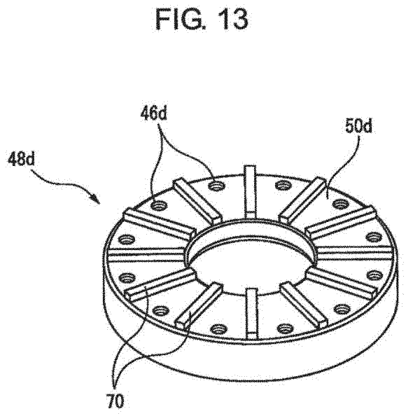

FIG. 12 is a graph for illustrating noise reduction effect when the flinger 48c illustrated in FIG. 8 is mounted to the electric motor 10. In FIG. 12, the horizontal axis represents a dimensionless number in proportion to rotation speed of the electric motor, and the vertical axis represents a dimensionless number in proportion to a level of sound caused by rotation of the electric motor. The level of sound was measured at a fixed position away from the flinger by a predetermined distance. Measurement results using the flinger 48c of FIG. 8 are shown as a graph 68, the measurement results using the flinger 49 of FIG. 3 are shown as the graph 56, and the measurement results using the flinger 49 of FIG. 3 with the tapped holes 47 all of which were filled with respective set screws, etc., (almost equivalent to that without the tapped hole 47) are shown as the graph 58 as the other (ideal) comparative example.

As can be seen from FIG. 12, when the flinger 49 was used, a level of sound at a rotation speed of about 170 became maximum (the graph 56). Even when the flinger 48c was used, a level of sound at a rotation speed of about 170 tended to become maximum. However, an in- and outflow rate of air into and from each of the tapped holes 46c is greatly reduced by the partition 60 as described above, so that a noise level in the second example can be greatly reduced as compared with that in the related art to be brought nearly close to that of the ideal product (graph 58).

In the measurement of FIG. 12, the partition 60 had a height h of 0.5 mm (refer to FIG. 11). However, the height is an example, and can be appropriately changed to 1 mm or less, 2 mm or less, 3 mm or less, etc., according to rotation speed and a level of noise.

FIG. 13 illustrates a structural example of a flinger 48d as a modification of the second example. The flinger 48d includes a plurality of tapped holes 46d into which a weight for balance adjustment is detachable, and partitions 70 formed downward of the corresponding tapped holes 46d in a rotation direction of the rotating shaft 18. The tapped holes 46d and the partitions 70 are here formed in an end face 50d of the flinger 48d on an opposite side in an axial direction of the electric motor to a side facing the inside of the electric motor 10. The partitions 70 are each formed in a portion downstream of the corresponding one of the tapped holes 46d on the end face 50d. While the partitions 70 are each formed as a protrusion radially extending from the rotation center in an intermediate portion between adjacent tapped holes 46d on the end face 50d in the example illustrated, the partitions 70 are not limited to this. Even when the flinger 48d of FIG. 13 is used, as in when the flinger 48c of FIG. 8 is used, an in- and outflow rate of air into and from each of the tapped holes 46d is greatly reduced by the corresponding partitions 70. This enables a noise level to be greatly reduced as compared with that in the related art.

While twelve tapped holes are formed in the end face of the flinger, at an equal interval of 30° in a circumferential direction about the axis 16, in each of the examples described above, the present disclosure is not limited to this. For example, four tapped holes may be formed in the end face of the flinger, at an equal interval of 90° in the circumferential direction, six tapped holes may be formed in the end face of the flinger, at an equal interval of 60° in the circumferential direction, or eight tapped holes may be formed in the end face of the flinger, at an equal interval of 45° in the circumferential direction. While an interval between a pair of tapped holes of a plurality of tapped holes may not be equal, it is preferable that tapped holes each with the same size be formed in the circumferential direction at an equal interval on a circle concentric with the rotation center in consideration of balance and eccentricity associated with rotation of a spindle. In addition, a tapped hole does not typically pass through a flinger (a tapped hole has a depth shorter than an axial length of a flinger). Further, the tapped hole may be provided in a face of the flinger other than an end face thereof (e.g., an outer lateral face).

It is preferable that the cut-outs and partitions in the examples described above be formed so as not to impair rotational symmetry of the flinger. This is because when the flinger itself is rotational asymmetric, it is very difficult to adjust rotation balance by inserting a set screw, etc., into the tapped hole.

When the flinger according to the present disclosure is applied to an electric motor (rotary electric machine), a noise associated with rotation of the electric motor can be greatly reduced without using a cover for preventing a noise or filling the tapped hole for a purpose other than balance adjustment. The flingers according to the examples described above each can be relatively easily manufactured by only modifying a die, so that there is also not much difference in cost from the flinger in the related art. In addition, when an electric motor with any one of the flingers according to the present disclosure is applied to a machine tool such as a NC lathe or a machining center, in which a spindle is typically rotated at high speed, a work environment with less noise can be achieved.

According to the present disclosure, a level of a sound generated during rotation of an electric motor, due to existence of a tapped hole, can be greatly reduced as compared with that in the related art.

While the invention has been described with reference to specific embodiments chosen for the purpose of illustration, it should be apparent that numerous modifications could be made thereto, by a person skilled in the art, without departing from the basic concept and scope of the invention.

1. A flinger mounted in an electric motor including a stator, a rotor with a rotating shaft rotatable about an axis of the stator, and a front bearing and a rear bearing configured to rotatably support the rotating shaft,
the flinger being mounted to one or both of a portion of the rotating shaft forward of the front bearing along the axis and a portion of the rotating shaft rearward of the rear bearing along the axis,
the flinger comprising:
a plurality of tapped holes; and
a cut-out cutting out a part of the respective tapped holes,
wherein the cut-out is formed as a slit cutting out a part of a lateral portion of each of the tapped holes in a longitudinal direction of each of the tapped holes.

2. The flinger of claim 1, wherein
the slit is formed not to open in an outer lateral face of the flinger.

3. An electric motor with the flinger of claim 1.
